(19) United States
(12) Patent Application Publication
(10) Pub. No.: US 2021/0094807 A1
(43) Pub. Date: Apr. 1, 2021

(54) ZERO-TURN RADIUS VEHICLE FOR FACILITATING TRANSPORTING OF OBJECTS

(71) Applicant: Robert Lee Fox, Grove, OK (US)

(72) Inventor: Robert Lee Fox, Grove, OK (US)

(21) Appl. No.: 17/033,550

(22) Filed: Sep. 25, 2020

Related U.S. Application Data
(60) Provisional application No. 62/908,248, filed on Sep. 30, 2019.

(51) Int. Cl. B66F 9/065; B62D 7/14; B62D 1/12; F15B 15/00; B66F 9/18; B66F 9/075; B66F 9/22

(52) U.S. Cl. CPC B66F 9/065; B62D 7/142; B62D 1/12; B66F 9/22; B66F 9/18; B66F 9/0759; B66F 9/07568; F15B 15/00

(57) ABSTRACT

Disclosed herein is a zero-turn radius vehicle for facilitating transporting of objects, in accordance with some embodiments. Accordingly, the zero-turn radius vehicle may include a frame. Further, the zero-turn radius vehicle may include a plurality of wheels rotatably coupled with the frame. Further, the zero-turn radius vehicle may include a propelling mechanism disposed of in the frame. Further, the propelling mechanism may be operationally coupled with the pair of opposing wheels. Further, the zero-turn radius vehicle may include an attachment member coupled to the frame. Further, the attachment member may be configured for moving between a plurality of positions. Further, the zero-turn radius vehicle may include a control member disposed of in the frame. Further, the control member may be operationally coupled with at least one of the propelling mechanism and the attachment member.

### FIELD OF THE INVENTION

Generally, the present disclosure relates to the field of transportation. More specifically, the present disclosure relates to a zero-turn radius vehicle for facilitating transporting of objects.

### BACKGROUND OF THE INVENTION

Existing techniques for facilitating transporting of objects are deficient with regard to several aspects. For instance, current technologies do not provide a high maneuverable vehicle that may grasp and load object for facilitating the transportation of the objects. Furthermore, grapples used in current vehicles for grasping and loading objects are expensive and too wide for use in confined spaces. Further, a wide jaw associated with the grapples complicates the picking of certain types of loads and obstruct the seated operator's vision. Therefore, there is a need for improved zero-turn radius vehicle for facilitating transporting of objects that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a zero-turn radius vehicle for facilitating transporting of objects, in accordance with some embodiments. Accordingly, the zero-turn radius vehicle may include a frame. Further, the zero-turn radius vehicle may include a plurality of wheels rotatably coupled with the frame. Further, the plurality of wheels may include a pair of opposing wheels. Further, the zero-turn radius vehicle may include a propelling mechanism disposed of in the frame. Further, the propelling mechanism may be operationally coupled with the pair of opposing wheels. Further, the propelling mechanism may be configured for rotating each wheel of the pair of opposing wheels independently. Further, the rotating of the each wheel independently maneuvers the zero-turn radius vehicle. Further, the zero-turn radius vehicle may include an attachment member coupled to the frame. Further, the attachment member may be configured for moving between a plurality of positions. Further, the attachment member may be configured for at least one of clamping and picking at least one object based on the moving between the plurality of positions. Further, the zero-turn radius vehicle may include a control member disposed of in the frame. Further, the control member may be operationally coupled with at least one of the propelling mechanism and the attachment member. Further, the control member may be configured for controlling the at least one of the propelling mechanism and the attachment member. Further, the control member may be configured for controlling the rotating of the each wheel of the pair of opposing wheels. Further, the control member may be configured for controlling the moving of the attachment member between the plurality of positions.

Further disclosed herein is a zero-turn radius vehicle for facilitating transporting of objects, in accordance with some embodiments. Accordingly, the zero-turn radius vehicle may include a frame. Further, the zero-turn radius vehicle may include a plurality of wheels rotatably coupled with the frame. Further, the plurality of wheels may include a pair of opposing wheels and at least one front wheel. Further, the at least one front wheel may be disposed of in a front portion of the frame. Further, the pair of opposing wheels may be disposed of in a rear portion of the frame. Further, the zero-turn radius vehicle may include a propelling mechanism disposed of in the frame. Further, the propelling mechanism may be operationally coupled with the pair of opposing wheels. Further, the propelling mechanism may not be operationally coupled with the at least one front wheel. Further, the propelling mechanism may be configured for rotating each wheel of the pair of opposing wheels independently. Further, the rotating of the each wheel independently maneuvers the zero-turn radius vehicle. Further, the zero-turn radius vehicle may include an attachment member coupled to the frame. Further, the attachment member may be configured for moving between a plurality of positions. Further, the attachment member may be configured for at least one of clamping and picking at least one object based on the moving between the plurality of positions. Further, the zero-turn radius vehicle may include a control member disposed of in the frame. Further, the control member may be operationally coupled with at least one of the propelling mechanism and the attachment member. Further, the control member may be configured for controlling the at least one of the propelling mechanism and the attachment member. Further, the control member may be configured for controlling the rotating of the each wheel of the pair of opposing wheels. Further, the control member may be configured for controlling the moving of the attachment member between the plurality of positions.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a left side perspective view of a zero-turn radius vehicle for facilitating transporting of objects, in accordance with some embodiments.

FIG. 2 is a left side perspective view of the zero-turn radius vehicle for facilitating transporting of the objects, in accordance with some embodiments.

FIG. 3 is a left side perspective view of a zero-turn radius vehicle for facilitating transporting of objects, in accordance with some embodiments.

FIG. 4 is a left side perspective of the zero-turn radius vehicle for facilitating transporting of the objects, in accordance with some embodiments.

FIG. 5 is a right perspective view of a zero-turn radius vehicle with a grapple for facilitating transporting of objects, in accordance with some embodiments.

FIG. 6 is a left side view of the zero-turn radius vehicle with the grapple, in accordance with some embodiments.

FIG. 7 is a front view of the zero-turn radius vehicle with the grapple, in accordance with some embodiments.

FIG. 8 is a top view of the zero-turn radius vehicle with the grapple, in accordance with some embodiments.

FIG. 9 is a left side view of the zero-turn radius vehicle with the grapple, in accordance with some embodiments.

FIG. 10 is a left side perspective view of the zero-turn radius vehicle for facilitating transporting of the objects, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of zero-turn radius vehicle for facilitating transporting of objects, embodiments of the present disclosure are not limited to use only in this context.

Overview:

The present disclosure describes a customized grapple loader with a specific design that is mounted to a zero turn yard tractor, powered by a 24 volt series of batteries that give power to an electric pump that operates 3 individual cylinders that give a lift to the arms and a grapple using separate controls that are mounted to the pump. Further, the present disclosure describes a mini monster grapple loader.

Further, the present disclosure describes highly maneuverable tractors that have a grapple capability. Further, the present disclosure describes the combining of zero-turn capabilities of zero-turn-radius lawnmowers and skid loaders with a grapple device. Zero-turn machines are typically configured with a prime mover mounted at the rear of the zero-turn machine, above the independently controlled drive wheels. Further, front wheels are used to provide maneuverability and easier steering. The front wheels may be unpowered casters, and the machine is steered by varying the relative speeds of the left and right drive wheels. Further, the skid loaders are highly maneuverable vehicles that have proven useful in the construction and landscaping fields for their ease of control and their ability to access cramped construction sites. Further, the skid loader may include at least one pair of opposing tracks/wheels. Further, the at least one pair of opposing wheels may be moved independently so that the skid loader can be turned through a very tight radius. Further, the skid loader may be turned on its lengthwise axis from a forward-facing position to a rear-facing position by moving a first set of tracks of the at least one pair of opposing wheels in a rearward direction and a second set of tracks of the at least one pair of opposing wheels in a forward direction. Further, the skid loaders are highly maneuverable, to the point of having a “zero turning radius” that may be beneficial for working inside buildings and in other sites that have limited working space. However, the skid loaders' high degree of maneuverability permits the skid loader to turn on a dime. Further, a seated operator of the skid loader may grasp and load things, owing to the configuration of attachments designed to load and grasp the things. Further, the attachments may include a grapple. Further, the grapple may include a hydraulically operated clamp whose pivotal jaws extend across the front of the zero-turn machine.

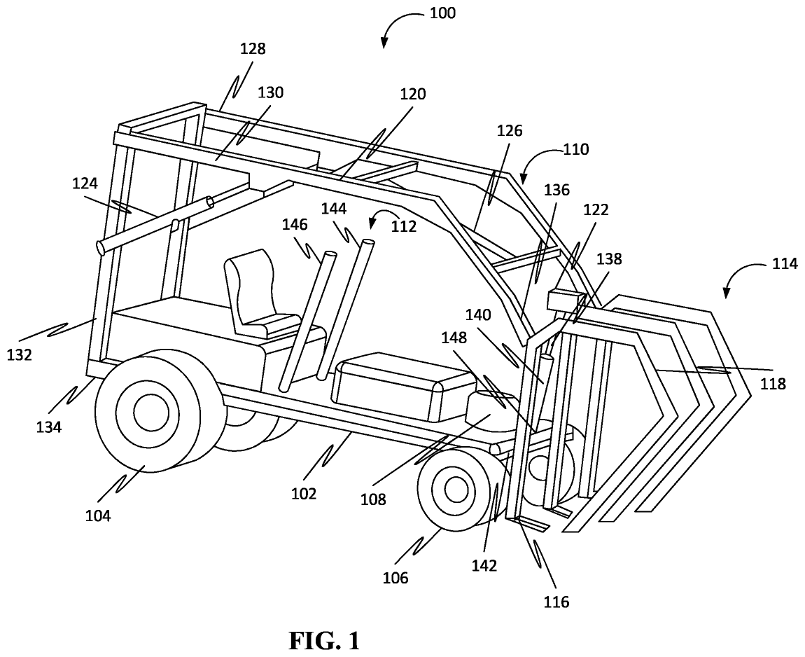

FIG. 1 is a left side perspective view of a zero-turn radius vehicle 100 for facilitating transporting of objects, in accordance with some embodiments. Accordingly, the zero-turn radius vehicle 100 may include a frame 102.

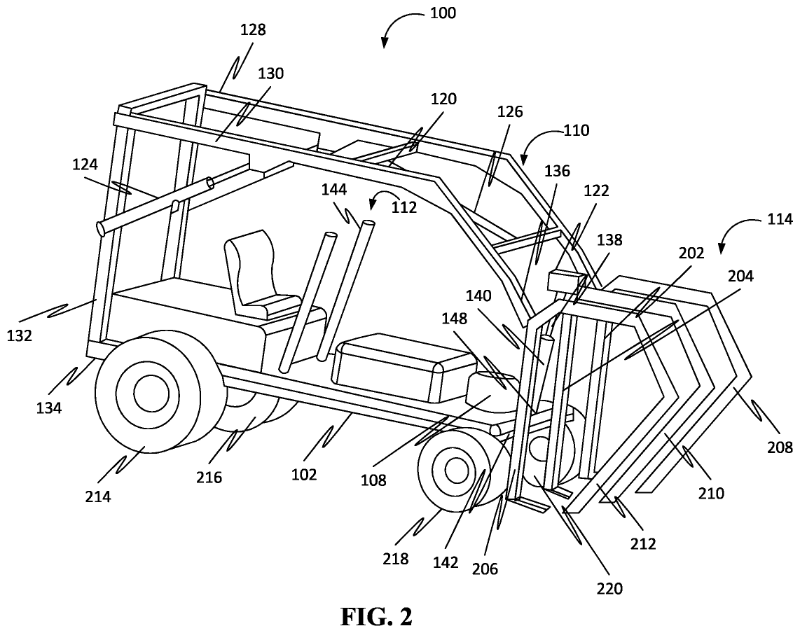

Further, the zero-turn radius vehicle 100 may include a plurality of wheels 104-106 rotatably coupled with the frame 102. Further, the plurality of wheels 104-106 may include a pair of opposing wheels 214-216 (as shown in FIG. 2).

Further, the zero-turn radius vehicle 100 may include a propelling mechanism 108 disposed of in the frame 102. Further, the propelling mechanism 108 may be operationally coupled with the pair of opposing wheels 214-216. Further, the propelling mechanism 108 may be configured for rotating each wheel of the pair of opposing wheels 214-216 independently. Further, the rotating of the each wheel independently maneuvers the zero-turn radius vehicle 100. Further, the propelling mechanism 108 may include at least one engine, at least one motor, etc. Further, the propelling mechanism 108 may be powered by at least one fuel, electricity, etc.

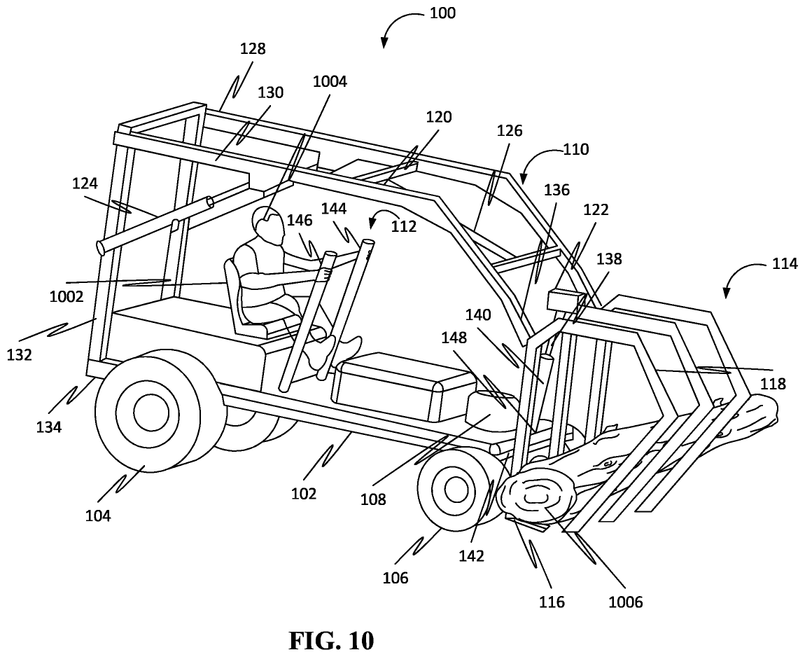

Further, the zero-turn radius vehicle 100 may include an attachment member 110 coupled to the frame 102. Further, the attachment member 110 may be configured for moving between a plurality of positions. Further, the attachment member 110 may be configured for at least one of clamping and picking at least one object 1006, as shown in FIG. 10, based on the moving between the plurality of positions.

Further, the zero-turn radius vehicle 100 may include a control member 112 disposed of in the frame 102. Further, the control member 112 may be operationally coupled with at least one of the propelling mechanism 108 and the attachment member 110. Further, the control member 112 may be configured for controlling the at least one of the propelling mechanism 108 and the attachment member 110. Further, the control member 112 may be configured for controlling the rotating of the each wheel of the pair of opposing wheels 214-216. Further, the control member 112 may be configured for controlling the moving of the attachment member 110 between the plurality of positions.

Further, in some embodiments, the attachment member 110 may include a grapple 114. Further, the grapple 114 may include a lower jaw 116 and an upper jaw 118. Further, the lower jaw 116 may include a lower bracket. Further, the upper jaw 118 may include an upper bracket. Further, the lower jaw 116 opposes the upper jaw 118. Further, a first end of each of the lower jaw 116 and the upper jaw 118 are pivotally coupled using at least one coupling mechanism. Further, the at least one coupling mechanism may include a hinge. Further, at least one of the lower jaw 116 and the upper jaw 118 may be configured for moving between a plurality of jaw positions. Further, the grapple 114 may be configured for at least one of the clamping and the picking of the at least one object 1006 based on the moving of the at least one of the lower jaw 116 and the upper jaw 118.

Further, in an embodiment, the grapple 114 may include a plurality of ribs. Further, the plurality of ribs may include a plurality of right-angled ribs 202-206 (as shown in FIG. 2) and a plurality of arcuate ribs 208-212 (as shown in FIG. 2). Further, the plurality of right-angled ribs 202-206 may be disposed of vertically in relation to a horizontal plane of the frame 102 forming the lower jaw 116. Further, the plurality of right-angled ribs 202-206 may be transversely spaced. Further, the plurality of arcuate ribs 208-212 may be disposed of laterally in relation to the horizontal plane forming the upper jaw 118. Further, the plurality of arcuate ribs 208-212 may be transversely spaced.

Further, in an embodiment, the attachment member 110 may include an arm member 120 and a mounting device 122. Further, the mounting device 122 may be pivotally attached to the arm member 120. Further, the grapple 114 may be mounted on the mounting device 122 for attaching the grapple 114 to the arm member 120.

Further, in some embodiments, the control member 112 may include an attachment control device (not shown). Further, the attachment control device may be operationally coupled with the attachment member 110. Further, the attachment control device may be configured for transitioning the attachment member 110 between the plurality of positions. Further, the controlling of the attachment member 110 may include the transitioning of the attachment member 110 between the plurality of positions.

Further, in an embodiment, the plurality of right-angled ribs 202-206 may be disposed vertically along a lateral length of the frame 102. Further, the plurality of arcuate ribs 208-212 may be disposed laterally along the lateral length of the frame 102.

Further, in an embodiment, the arm member 120 may include a plurality of arms and a hydraulic drive system 124-126. Further, the hydraulic drive system 124-126 may be coupled with the plurality of arms. Further, the hydraulic drive system 124-126 may be configured for moving the plurality of arms between a plurality of arm positions. Further, the moving of the plurality of arms corresponds to the moving of the attachment member 110.

Further, in an embodiment, the plurality of arms may include a pair of parallelly spaced arms 128-130. Further, a first end 132 of the pair of parallelly spaced arms 128-130 may be attached to a rear portion 134 of the frame 102 and a second end 136 of the pair of parallelly spaced arms 128-130 extends to a front portion 142 of the frame 102 over the frame 102. Further, the hydraulic drive system 124-126 may be configured for moving the pair of parallelly spaced arms 128-130 between the plurality of arm positions. Further, the mounting device 122 may be attached to the second end 136 of the pair of parallelly spaced arms 128-130.

Further, in an embodiment, the grapple 114 may be coupled with the hydraulic drive system 124-126. Further, a first end 138 of a hydraulic cylinder 140 of the hydraulic drive system 124-126 may be coupled with the upper jaw 118. Further, a second end 148 of the hydraulic cylinder 140 may be coupled with the lower jaw 116. Further, a plurality of hydraulic pumps of the hydraulic drive system 124-126 may be configured for actuating the hydraulic cylinder 140 using a hydraulic fluid. Further, the hydraulic cylinder 140 may be configured for moving the at least one of the upper jaw 118 and the lower jaw 116 based on the actuating.

Further, in some embodiments, the plurality of wheels 104-106 may include at least one front wheel 218-220 (as shown in FIG. 2). Further, the at least one front wheel 218-220 may be disposed of in the front portion 142 of the frame 102. Further, the pair of opposing wheels 214-216 may be disposed of in the rear portion 134 of the frame 102. Further, the propelling mechanism 108 may not be operationally coupled with the at least one front wheel 218-220.

Further, in an embodiment, the at least one front wheel 218-220 may be a caster-type wheel. Further, the caster-type wheel may be configured for rotating about a horizontal axis of the caster-type wheel and a vertical axis of the caster-type wheel.

Further, in some embodiments, the control member 112 may include a steering mechanism. Further, the steering mechanism may include a pair of levers 144-146. Further, each lever of the pair of levers 144-146 may be operationally coupled with the each wheel of the pair of opposing wheels 214-216. Further, the each lever may be configured for controlling the rotating of the each wheel of the pair of opposing wheels 214-216.

FIG. 2 is a left side perspective view of the zero-turn radius vehicle 100 for facilitating transporting of the objects, in accordance with some embodiments.

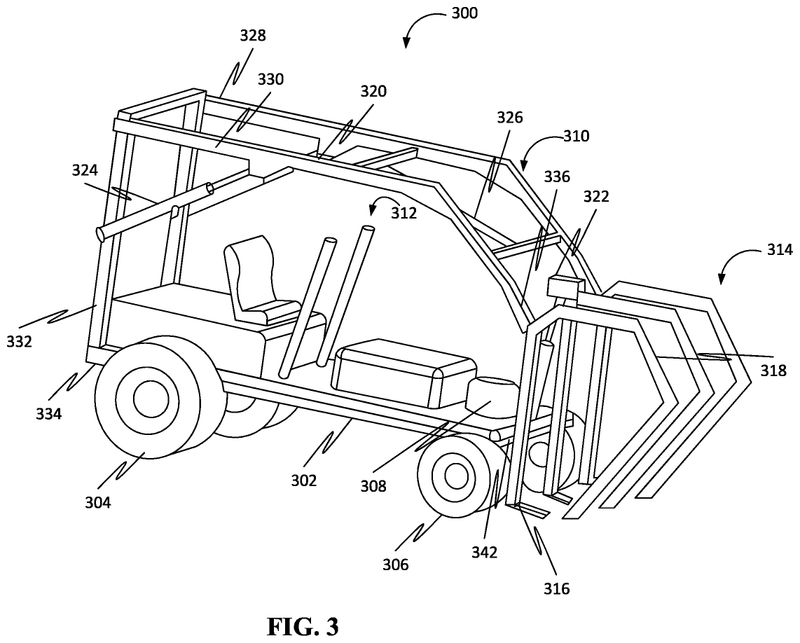

FIG. 3 is a left side perspective view of a zero-turn radius vehicle 300 for facilitating transporting of objects, in accordance with some embodiments. Accordingly, the zero-turn radius vehicle 300 may include a frame 302.

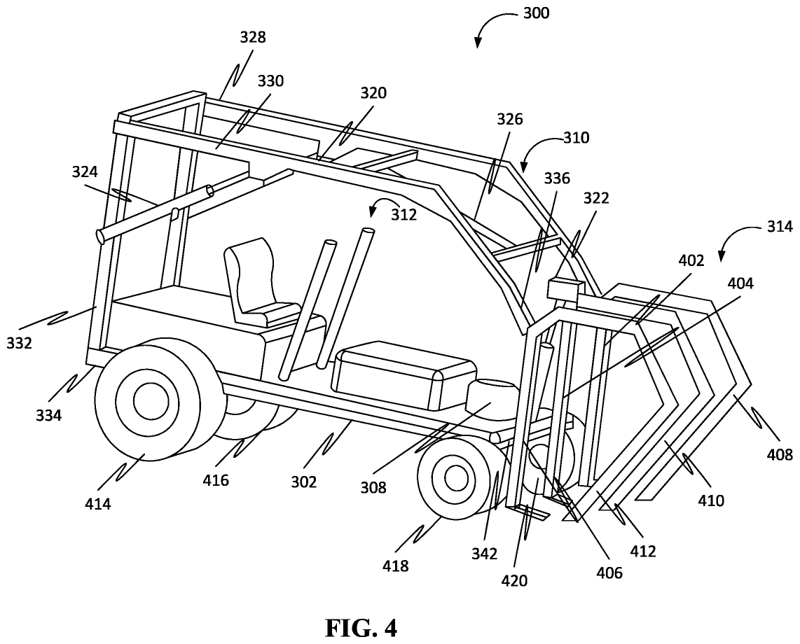

Further, the zero-turn radius vehicle 300 may include a plurality of wheels 304-306 rotatably coupled with the frame 302. Further, the plurality of wheels 304-306 may include a pair of opposing wheels 414-416 (as shown in FIG. 4) and at least one front wheel 418-420 (as shown in FIG. 4). Further, the at least one front wheel 418-420 may be disposed of in a front portion 342 of the frame 302. Further, the pair of opposing wheels 414-416 may be disposed of in a rear portion 334 of the frame 302.

Further, the zero-turn radius vehicle 300 may include a propelling mechanism 308 disposed of in the frame 302. Further, the propelling mechanism 308 may be operationally coupled with the pair of opposing wheels 414-416. Further, the propelling mechanism 308 may not be operationally coupled with the at least one front wheel 418-420. Further, the propelling mechanism 308 may be configured for rotating each wheel of the pair of opposing wheels 414-416 independently. Further, the rotating of the each wheel independently maneuvers the zero-turn radius vehicle 300. Further, the propelling mechanism 308 may include at least one engine, at least one motor, etc. Further, the propelling mechanism 308 may be powered by at least one fuel, electricity, etc.

Further, the zero-turn radius vehicle 300 may include an attachment member 310 coupled to the frame 302. Further, the attachment member 310 may be configured for moving between a plurality of positions. Further, the attachment member 310 may be configured for at least one of clamping and picking at least one object based on the moving between the plurality of positions.

Further, the zero-turn radius vehicle 300 may include a control member 312 disposed of in the frame 302. Further, the control member 312 may be operationally coupled with at least one of the propelling mechanism 308 and the attachment member 310. Further, the control member 312 may be configured for controlling the at least one of the propelling mechanism 308 and the attachment member 310. Further, the control member 312 may be configured for controlling the rotating of the each wheel of the pair of opposing wheels 414-416. Further, the control member 312 may be configured for controlling the moving of the attachment member 310 between the plurality of positions.

Further, in some embodiments, the attachment member 310 may include a grapple 314. Further, the grapple 314 may include a lower jaw 316 and an upper jaw 318. Further, the lower jaw 316 may include a lower bracket. Further, the upper jaw 318 may include an upper bracket. Further, the lower jaw 316 opposes the upper jaw 318. Further, a first end of each of the lower jaw 316 and the upper jaw 318 are pivotally coupled using at least one coupling mechanism. Further, the at least one coupling mechanism may include a hinge. Further, at least one of the lower jaw 316 and the upper jaw 318 may be configured for moving between a plurality of jaw positions. Further, the grapple 314 may be configured for at least one of the clamping and the picking of the at least one object based on the moving of the at least one of the lower jaw 316 and the upper jaw 318.

Further, in some embodiments, the control member 312 may include an attachment control device (not shown). Further, the attachment control device may be operationally coupled with the attachment member 310. Further, the attachment control device may be configured for transitioning the attachment member 310 between the plurality of positions. Further, the controlling of the attachment member 310 may include the transitioning of the attachment member 310 between the plurality of positions.

Further, in an embodiment, the grapple 314 may include a plurality of ribs. Further, the plurality of ribs may include a plurality of right-angled ribs 402-406 (as shown in FIG. 4) and a plurality of arcuate ribs 408-412 (as shown in FIG. 4). Further, the plurality of right-angled ribs 402-406 may be disposed of vertically in relation to a horizontal plane of the frame 302 forming the lower jaw 316. Further, the plurality of right-angled ribs 402-406 may be transversely spaced. Further, the plurality of arcuate ribs 408-412 may be disposed of laterally in relation to the horizontal plane forming the upper jaw 318. Further, the plurality of arcuate ribs 408-412 may be transversely spaced.

Further, in an embodiment, the plurality of right-angled ribs 402-406 may be disposed vertically along a lateral length of the frame 302. Further, the plurality of arcuate ribs 408-412 may be disposed laterally along the lateral length of the frame 302.

Further, in an embodiment, the attachment member 310 may include an arm member 320 and a mounting device 322. Further, the mounting device 322 may be pivotally attached to the arm member 320. Further, the grapple 314 may be mounted on the mounting device 322 for attaching the grapple 314 to the arm member 320.

Further, in an embodiment, the arm member 320 may include a plurality of arms and a hydraulic drive system 324-326. Further, the hydraulic drive system 324-326 may be coupled with the plurality of arms. Further, the hydraulic drive system 324-326 may be configured for moving the plurality of arms between a plurality of arm positions. Further, the moving of the plurality of arms corresponds to the moving of the attachment member 310.

Further, in an embodiment, the plurality of arms may include a pair of parallelly spaced arms 328-330. Further, a first end 332 of the pair of parallelly spaced arms 328-330 may be attached to the rear portion 334 of the frame 302 and a second end 336 of the pair of parallelly spaced arms 328-330 extends to the front portion 342 of the frame 302 over the frame 302. Further, the hydraulic drive system 324-326 may be configured for moving the pair of parallelly spaced arms 328-330 between the plurality of arm positions. Further, the mounting device 322 may be attached to the second end 336 of the pair of parallelly spaced arms 328-330.

FIG. 4 is a left side perspective view of the zero-turn radius vehicle 300 for facilitating transporting of the objects, in accordance with some embodiments.

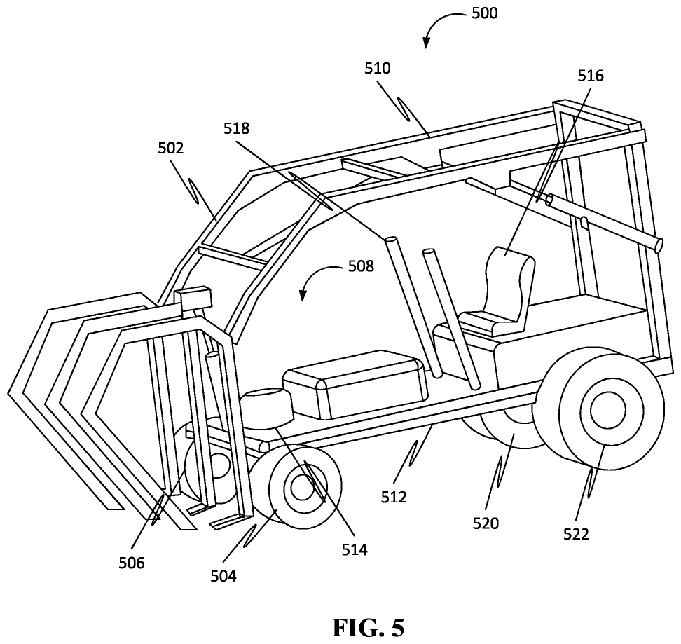

FIG. 5 is a right perspective view of a zero-turn radius vehicle 500 with a grapple 502 for facilitating transporting of objects, in accordance with some embodiments. Accordingly, the zero-turn radius vehicle 500 may include a tractor. The tractor is made of relatively lightweight material, allowing environmentally friendly operation (especially in yards) using electrically powered hydraulic pumps. Further, front wheels 504-506 are configured for high maneuverability, and the grapple 502 may be configured not to interfere with the tractor's movements or the operator's vision. The front wheels 504-506 are configured to provide high maneuverability and easy steering. Further, the tractor may include a vehicle member 508 and an attachment member 510. Further, the vehicle member 508 may be configured to provide high maneuverability. The attachment member 510 may be attached to the vehicle member 508 and may be used to clamp and pick up a wide range of products.

Further, in an embodiment, the vehicle member 508 may comprise a frame 512, a plurality of wheels, an engine 514, a seat member 516, and a control member 518. The frame 512 may be made from any suitable lightweight material, including metals and fiber-reinforced metals (e.g., aluminum, copper), that has the stiffness and strength to support the vehicle member 508.

The engine 514 may include a drive shaft that may be horizontal, vertical, or angled. In an embodiment, the engine 514 may be a V-twin, four-cycle gasoline engine and may include a plurality of cylinders. The engine 514 may consume diesel fuel, liquid propane, fuel oil, natural gas, alcohol, kerosene, or hydrogen. In some embodiments, the engine 514 may include an electric motor and draw electrical power from an onboard electrical storage device (e.g., a battery pack, a fuel cell).

The seat member 516 may include a seat for the operator and an enclosure or cover to shield the operator for safety purposes. The enclosure may include a metal cage with a mesh net configured to protect the operator from being hit by falling objects when driving the tractor device.

In an embodiment, the plurality of wheels may be positioned in the front area and the rear area, coupled to the underside of the frame 512. In another embodiment, the vehicle member 508 may include the front wheels 504-506 and a pair of rear wheels 520-522, with the front wheels 504-506 generally aligned with a centerline of the engine 514 at the forward end of the frame 512. The front wheels 504-506 may be connected to each other by a shaft, and the rear wheels 520-522 may be connected to the engine 514 by a plurality of shafts. The rear wheels 520-522 may include a tire on a rim that is rotatably coupled to the rear end of the frame 512 on a transaxle supported by bearings. The rear wheels 520-522 propel the tractor and steer the tractor by varying the relative speed between the rear wheels 520-522. For example, by keeping a first rear wheel 520 of the rear wheels 520-522 stationary and rotating a second rear wheel 522 of the rear wheels 520-522, the tractor may turn about the first wheel 520. A tighter, “zero radius” turn may be achieved by rotating the second rear wheel 522 forward and the first rear-wheel 520 backward, causing the tractor to rotate about a point between the rear wheels 520-522.

The front wheels 504-506 may be coupled to the front end of the frame 512. In an embodiment, the front wheels 504-506 may be a nonpowered caster-type wheel configured to rotate (e.g., about a horizontal axis of rotation) and turn (e.g., about a vertical axis of rotation) freely. The vehicle member 508 may include the front wheels 504-506 located in the front area of the vehicle member 508.

The seat member 516 may be positioned substantially in the central area of the frame 512. In an embodiment, the seat member 516 may be in any suitable shape, including triangular or rectangular.

The control member 518 may include various mechanisms to control the tractor—for example, an on/off switch, a throttle control, and a choke control—as well as devices to operate attachments that may include the grapple 502. The control member 518 may further include a steering mechanism. Further, in an embodiment, the steering mechanism may include a pair of levers, with one provided on either side of the vehicle member 508. In an embodiment, the pair of levers may be configured to control the rear wheels 520-522.

The attachment member 510 may comprise the grapple 502 and an arm member. The grapple 502, which may be attached to the arm member, may comprise a lower jaw and an upper jaw. The lower jaw and the upper jaw may be pivotally connected at one end by means of a hinge pin. The attachment member 510 may further include a mounting device. In one example, the mounting device can be pivotally attached to the arm member. The upper and lower jaws can also be mounted on the mounting device so that the grapple 502 may be connected to the arm member. In one aspect, the grapple 502 may be narrower, or at least no wider, than the width of the tractor, so that the grapple 502 may be used in any physical surroundings where the tractor may fit while retaining sufficient gripping power and torsional resistance to picking up a wide variety of unbalanced loads. The lower jaw of the grapple 502 may comprise a plurality of transversely spaced, vertically disposed ribs. The upper jaw may comprise a plurality of spaced arcuate ribs. The grapple 502 may also include a plurality of crossbars attached to the lower jaw and the upper jaw.

The arm member may include a plurality of arms and a hydraulic drive system. In one embodiment, the plurality of arms may include a pair of parallel spaced arms that extend forward from the rear area of the vehicle member 508. The pair of parallel spaced arms may be raised or lowered using the hydraulic drive system, which may include hydraulic fluid, a plurality of hydraulic pumps, and hydraulic cylinders with which to lower or raise the arms.

In an embodiment of the present invention, the grapple 502 may be operated by a single hydraulic cylinder that is inexpensive and easy to replace. Further, the grapple 502 may include a first bracket and a second bracket. One end of the single hydraulic cylinder can be mounted on the first bracket, attached to the mounting device, and the other end of the single hydraulic cylinder can be mounted on the second bracket, attached to one of the crossbars, substantially in the central area of the crossbar. The single hydraulic cylinder may be supplied with hydraulic fluid by the hydraulic drive system. In one aspect, the hydraulic pumps of the hydraulic drive system and the single hydraulic cylinder attached to the grapple 502 may be powered by a 24-volt series of batteries and the grapple 502 may include a separate control device mounted on the single hydraulic cylinder.

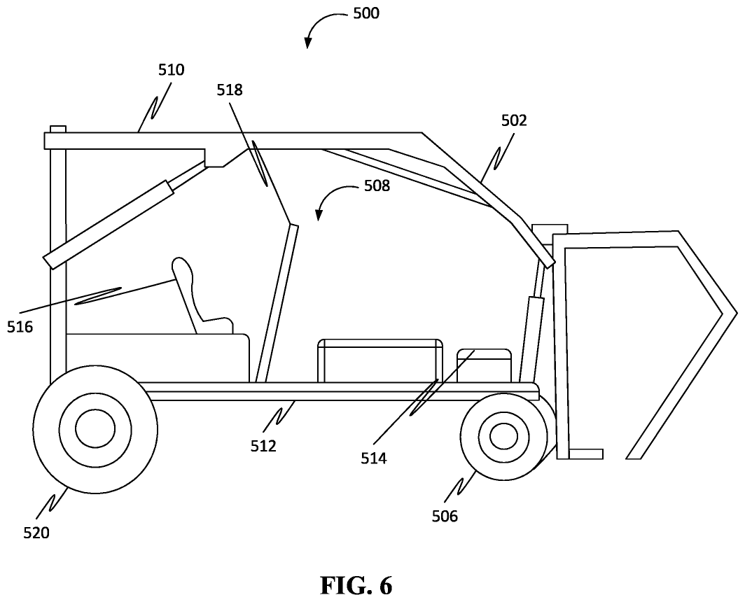

FIG. 6 is a left side view of the zero-turn radius vehicle 500 with the grapple 502, in accordance with some embodiments.

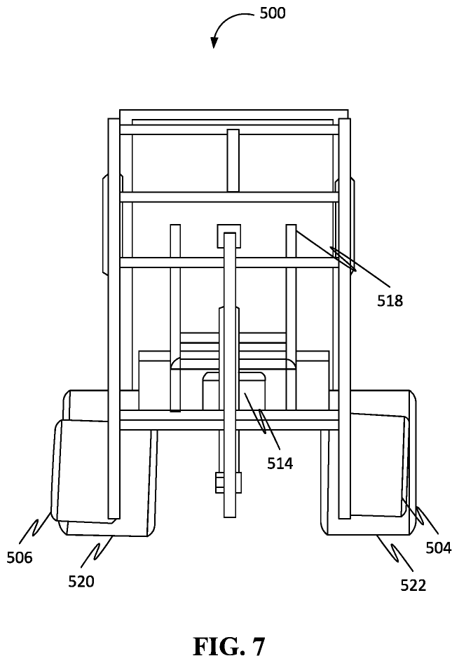

FIG. 7 is a front view of the zero-turn radius vehicle 500 with the grapple 502, in accordance with some embodiments.

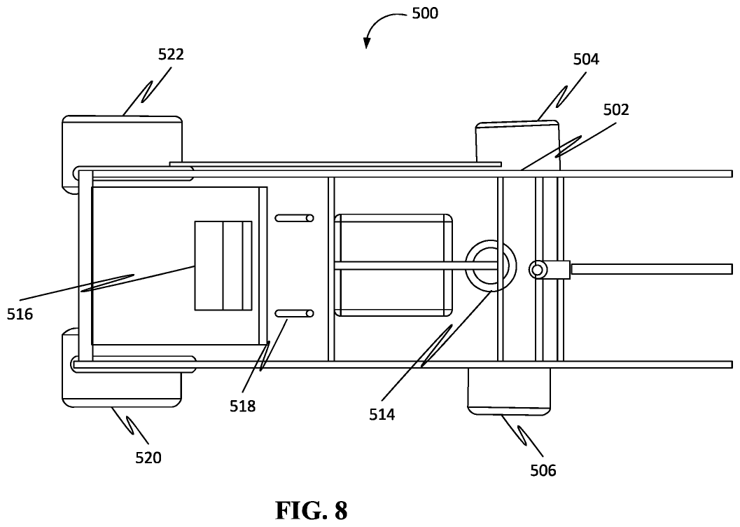

FIG. 8 is a top view of the zero-turn radius vehicle 500 with the grapple 502, in accordance with some embodiments.

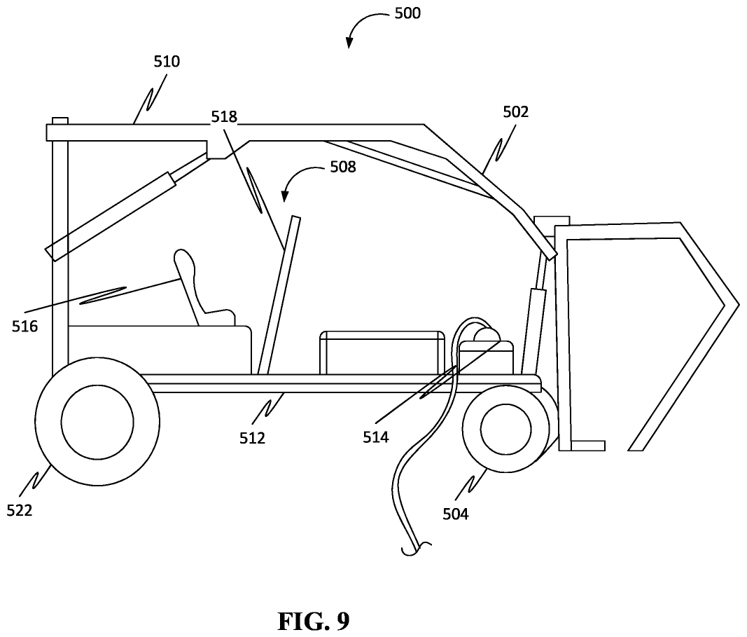

FIG. 9 is a left side view of the zero-turn radius vehicle 500 with the grapple 502, in accordance with some embodiments.

FIG. 10 is a left side perspective view of the zero-turn radius vehicle 100 for facilitating transporting of the objects, in accordance with some embodiments. Further, the zero-turn radius vehicle 100 may include a seat member 1002. Further, the seat member 1002 may be configured for providing a sitting space for at least one individual 1004. Further, the at least one individual 1004 may be able to sit in the seat member 1002. Further, the control member 112 may be disposed proximal to the seat member 1002. Further, the at least one individual 1004 may be able to control the propelling mechanism 108 and the attachment member 110 by performing at least one action on the control member 112. Further, the at least one action may include pushing, pulling, rotating, swiveling, twisting at least one of the pair of levers 144-146 of the steering mechanism of the control member 112. Further, the attachment member 110 may be configured for at least one of clamping and picking at least one object 1006. Further, the at least one of the clamping and the picking may allow at least one of transporting, stacking, piling, etc. of the at least one object 1006. Further, the at least one object 1006 may include a log, a branch, a package, a load, a thing, etc.

Although the present disclosure has been explained in relation to its preferred embodiment, it is to be understood that many other possible modifications and variations can be made without departing from the spirit and scope of the disclosure.

The following is claimed:

1. A zero-turn radius vehicle for facilitating transporting of objects, the zero-turn radius vehicle comprising:
a frame;
a plurality of wheels rotatably coupled with the frame, wherein the plurality of wheels comprises a pair of opposing wheels;
a propelling mechanism disposed of in the frame, wherein the propelling mechanism is operationally coupled with the pair of opposing wheels, wherein the propelling mechanism is configured for rotating each wheel of the pair of opposing wheels independently, wherein the rotating of x wheel independently maneuvers the zero-turn radius vehicle;
an attachment member coupled to the frame, wherein the attachment member is configured for moving between a plurality of positions, wherein the attachment member is configured for at least one of clamping and picking at least one object based on the moving between the plurality of positions; and
a control member disposed of in the frame, wherein the control member is operationally coupled with at least one of the propelling mechanism and the attachment member, wherein the control member is configured for controlling the at least one of the propelling mechanism and the attachment member, wherein the control member is configured for controlling the rotating of the each wheel of the pair of opposing wheels, wherein the control member is configured for controlling the moving of the attachment member between the plurality of positions.

2. The zero-turn radius vehicle of claim 1, wherein the attachment member comprises a grapple, wherein the grapple comprises a lower jaw and an upper jaw, wherein the lower jaw opposes the upper jaw, wherein a first end of each of the lower jaw and the upper jaw are pivotally coupled using at least one coupling mechanism, wherein at least one of the lower jaw and the upper jaw is configured for moving between a plurality of jaw positions, wherein the grapple is configured for at least one of the clamping and the picking of the at least one object based on the moving of the at least one of the lower jaw and the upper jaw.

3. The zero-turn radius vehicle of claim 1, wherein the control member comprises an attachment control device, wherein the attachment control device is operationally coupled with the attachment member, wherein the attachment control device is configured for transitioning the attachment member between the plurality of positions, wherein the controlling of the attachment member comprises the transitioning of the attachment member between the plurality of positions.

4. The zero-turn radius vehicle of claim 2, wherein the grapple comprises a plurality of ribs, wherein the plurality of ribs comprises a plurality of right-angled ribs and a plurality of arcuate ribs, wherein the plurality of right-angled ribs is disposed of vertically in relation to a horizontal plane of the frame forming the lower jaw, wherein the plurality of right-angled ribs is transversely spaced, wherein the plurality of arcuate ribs is disposed of laterally in relation to the horizontal plane forming the upper jaw, wherein the plurality of arcuate ribs is transversely spaced.

5. The zero-turn radius vehicle of claim 4, wherein the plurality of right-angled ribs is disposed vertically along a lateral length of the frame, wherein the plurality of arcuate ribs is disposed laterally along the lateral length of the frame.

6. The zero-turn radius vehicle of claim 2, wherein the attachment member further comprises an arm member and a mounting device, wherein the mounting device is pivotally attached to the arm member, wherein the grapple is mounted on the mounting device for attaching the grapple to the arm member.

7. The zero-turn radius vehicle of claim 6, wherein the arm member comprises a plurality of arms and a hydraulic drive system, wherein the hydraulic drive system is coupled with the plurality of arms, wherein the hydraulic drive system is configured for moving the plurality of arms between a plurality of arm positions, wherein the moving of the plurality of arms corresponds to the moving of the attachment member.

8. The zero-turn vehicle of claim 7, wherein the plurality of arms comprises a pair of parallelly spaced arms, wherein a first end of the pair of parallelly spaced arms is attached to a rear portion of the frame and a second end of the pair of parallelly spaced arms extends to a front portion of the frame over the frame, wherein the hydraulic drive system is configured for moving the pair of parallelly spaced arms between the plurality of arm positions, wherein the mounting device is attached to the second end of the pair of parallelly spaced arms.

9. The zero-turn vehicle of claim 7, wherein the grapple is coupled with the hydraulic drive system, wherein a first end of a hydraulic cylinder of the hydraulic drive system is coupled with the upper jaw, wherein a second end of the hydraulic cylinder is coupled with the lower jaw, wherein a plurality of hydraulic pumps of the hydraulic drive system is configured for actuating the hydraulic cylinder using a hydraulic fluid, wherein the hydraulic cylinder is configured for moving the at least one of the upper jaw and the lower jaw based on the actuating.

10. The zero-turn vehicle of claim 1, wherein the plurality of wheels further comprises at least one front wheel, wherein the at least one front wheel is disposed of in a front portion of the frame, wherein the pair of opposing wheels is disposed of in a rear portion of the frame, wherein the propelling mechanism is not operationally coupled with the at least one front wheel.

11. The zero-turn vehicle of claim 10, wherein the at least one front wheel is a caster-type wheel, wherein the caster-type wheel is configured for rotating about a horizontal axis of the caster-type wheel and a vertical axis of the caster-type wheel.

12. The zero-turn vehicle of claim 1, wherein the control member comprises a steering mechanism, wherein the steering mechanism comprises a pair of levers, wherein each lever of the pair of levers is operationally coupled with the each wheel of the pair of opposing wheels, wherein the each lever is configured for controlling the rotating of the each wheel of the pair of the opposing wheels.

13. A zero-turn radius vehicle for facilitating transporting of objects, the zero-turn radius vehicle comprising:
a frame;
a plurality of wheels rotatably coupled with the frame, wherein the plurality of wheels comprises a pair of opposing wheels and at least one front wheel, wherein the at least one front wheel is disposed of in a front portion of the frame, wherein the pair of opposing wheels is disposed of in a rear portion of the frame;
a propelling mechanism disposed of in the frame, wherein the propelling mechanism is operationally coupled with the pair of opposing wheels, wherein the propelling mechanism is not operationally coupled with the at least one front wheel, wherein the propelling mechanism is configured for rotating each wheel of the pair of opposing wheels independently, wherein the rotating of the each wheel independently maneuvers the zero-turn radius vehicle;
an attachment member coupled to the frame, wherein the attachment member is configured for moving between a plurality of positions, wherein the attachment member is configured for at least one of clamping and picking at least one object based on the moving between the plurality of positions; and
a control member disposed of in the frame, wherein the control member is operationally coupled with at least one of the propelling mechanism and the attachment member, wherein the control member is configured for controlling the at least one of the propelling mechanism and the attachment member, wherein the control member is configured for controlling the rotating of the each wheel of the pair of opposing wheels, wherein the control member is configured for controlling the moving of the attachment member between the plurality of positions.

14. The zero-turn radius vehicle of claim 13, wherein the attachment member comprises a grapple, wherein the grapple comprises a lower jaw and an upper jaw, wherein the lower jaw opposes the upper jaw, wherein a first end of each of the lower jaw and the upper jaw are pivotally coupled using at least one coupling mechanism, wherein at least one of the lower jaw and the upper jaw is configured for moving between a plurality of jaw positions, wherein the grapple is configured for at least one of the clamping and the picking of the at least one object based on the moving of the at least one of the lower jaw and the upper jaw.

15. The zero-turn radius vehicle of claim 13, wherein the control member comprises an attachment control device, wherein the attachment control device is operationally coupled with the attachment member, wherein the attachment control device is configured for transitioning the attachment member between the plurality of positions, wherein the controlling of the attachment member comprises the transitioning of the attachment member between the plurality of positions.

16. The zero-turn radius vehicle of claim 14, wherein the grapple comprises a plurality of ribs, wherein the plurality of ribs comprises a plurality of right-angled ribs and a plurality of arcuate ribs, wherein the plurality of right-angled ribs is disposed of vertically in relation to a horizontal plane of the frame forming the lower jaw, wherein the plurality of right-angled ribs is transversely spaced, wherein the plurality of arcuate ribs is disposed of laterally in relation to the horizontal plane forming the upper jaw, wherein the plurality of arcuate ribs is transversely spaced.

17. The zero-turn radius vehicle of claim 16, wherein the plurality of right-angled ribs is disposed vertically along a lateral length of the frame, wherein the plurality of arcuate ribs is disposed laterally along the lateral length of the frame.

18. The zero-turn radius vehicle of claim 14, wherein the attachment member further comprises an arm member and a mounting device, wherein the mounting device is pivotally attached to the arm member, wherein the grapple is mounted on the mounting device for attaching the grapple to the arm member.

19. The zero-turn radius vehicle of claim 18, wherein the arm member comprises a plurality of arms and a hydraulic drive system, wherein the hydraulic drive system is coupled with the plurality of arms, wherein the hydraulic drive system is configured for moving the plurality of arms between a plurality of arm positions, wherein the moving of the plurality of arms corresponds to the moving of the attachment member.

20. The zero-turn vehicle of claim 19, wherein the plurality of arms comprises a pair of parallelly spaced arms, wherein a first end of the pair of parallelly spaced arms is attached to a rear portion of the frame and a second end of the pair of parallelly spaced arms extends to a front portion of the frame over the frame, wherein the hydraulic drive system is configured for moving the pair of parallelly spaced arms between the plurality of arm positions, wherein the mounting device is attached to the second end of the pair of parallelly spaced arms.
